(19) United States
(12) Patent Application Publication
(10) Pub. No.: US 2016/0116991 A1
(43) Pub. Date: Apr. 28, 2016

(54) KEYBOARD

(71) Applicant: FANUC Corporation, Yamanashi (JP)

(72) Inventors: Hiroyuki SUWA, Yamanashi (JP); Yoshiaki KUROBE, Yamanashi (JP)

(21) Appl. No.: 14/920,429

(22) Filed: Oct. 22, 2015

(30) Foreign Application Priority Data
Oct. 23, 2014 (JP) 2014-216566

(51) Int. Cl. G06F 3/02

(52) U.S. Cl. CPC G06F 3/02

(57) ABSTRACT

A keyboard having a plurality of contactless switches, the keyboard includes a signal conversion circuit allocating an input signal line from a control device and an output signal line to the control device for each operating switch of the contactless switches, wherein the signal conversion circuit is configured to output the signal of the input signal line allocated to the operating switch to the output line allocated to the operating switch when the contactless switch is operated.

### BACKGROUND OF THE INVENTION

1. Field of the Invention

The present invention relates to a keyboard for inputting data and various kinds of commands.

2. Description of the Related Art

A matrix keyboard is known as a keyboard for inputting data and various kinds of commands to various kinds of electric devices. The matrix keyboard includes a plurality of longitudinal lines and a plurality of lateral lines and has a switch structure, that is, a contact point, at an intersection point of the longitudinal line and the lateral line, such that the longitudinal line and the lateral line are conducted to each other when the switch is turned on.

FIG. 1 is a diagram illustrating principle of a matrix keyboard. Switch structures, i.e. contact points SW, are provided at intersection points of longitudinal lines 1, 2, 3, 4, 5 and so on and Lateral lines A, B, C, D, E and so on. For example, when a switch SW3c provided on the intersection point of a longitudinal line 3 and a lateral line C is turned on, the longitudinal line 3 and the lateral line C are conducted to each other. All combination of the longitudinal lines and the lateral lines are confirmed, and since only the longitudinal line 3 and the lateral line C are conducted to each other, it is determined that only the switch SW3c is turned on.

As a prior art for the matrix keyboard, a technique in which number of output lines is decreased and it is determined that more than one switches are turned on simultaneously by erroneous operation (Japanese Patent Laid-Open No. 6-161633), a technique in which a matrix keyboard with an enlarged key pitch and an enlarged key stroke is mounted on a ten keypad of a mobile phone so as to overlap with the ten keypad (Japanese Patent Laid-Open No. 2005-244913), a technique in which different key inputs are enabled by different stroke at turning on the key (Japanese Patent Laid-Open No.5-325719), and the like are known.

There are a lot of keyboards including a type using a contact switch, a type using a contactless switch, and the like, and the keyboard is selected based on a use, design, operability, and the like.

There is a case in which a keyboard using contact switches is changed to a keyboard using contactless switches such as a capacitance touch switch, in a system connecting a matrix keyboard using a contract switch and a control device via a line. The methods for change the keyboard includes a method in which contactless switches and contact points corresponding to the contactless switches are added, a method in which a line connecting the keyboard and the control device and an input circuit in the control device, i.e. a signal input circuit of the keyboard, are changed. However these methods require troublesome change operation and simple conversion to the contactless switches is difficult.

### SUMMARY OF THE INVENTION

In view of the above-described problems in the prior art techniques, a purpose of the present invention is to provide a keyboard in which a keyboard is easily changed to a keyboard using contactless switches in a system connecting a matrix keyboard using contact switches and a control device via a line.

The keyboard according to the present invention has a plurality of contactless switches, and the keyboard includes a signal conversion circuit allocating an input signal line from a control device and an output signal line to the control device for each operating switch of the contactless switches, wherein the signal conversion circuit is configured to output the signal of the input signal line allocated to the operating switch to the output line allocated to the operating switch when the contactless switch is operated. More specifically, the signal conversion circuit includes a PLD, the PLD being a programmable IC. In addition to that, the plurality of contactless switches are provided on a film attached on a screen of a display unit.

Since the keyboard in the present invention comprises the contactless switches and the signal conversion circuit, only connection of the input signal lines, output signal lines, and each contactless switch to the signal conversion circuit is required. Therefore, the matrix keyboard using the contact switches are easily changed to the keyboard using the contactless switches. The matrix keyboard using the contact switches can be more easily changed to the keyboard using the contactless switches especially when the signal conversion circuit includes a PLD, the PLD being a programmable IC.

### BRIEF DESCRIPTION OF THE DRAWINGS

The above-described object, the other object, and the feature of the invention will be proved from the description of embodiments below with reference to the accompanying drawings. In these drawings:

FIG. 1 is a diagram illustrating principle of a matrix keyboard.

FIG. 2 is a schematic diagram illustrating a system in which a matrix keyboard with contact switches and a control device is connected via a line in the prior art.

FIG. 3 is a diagram illustrating operation of input signal (INPUT 1 to INPUT 3), keyboard operation, output signal (OUTPUT A to OUTPUT C) in the prior art.

FIG. 4 is a schematic diagram of a system using a keyboard with contactless switches according to an embodiment in the present invention.

FIG. 5 is a diagram illustrating input and output allocated to each contactless switches and operation according to an embodiment in the present invention.

FIG. 6 is a diagram illustrating relation between input, each contactless switches, and output according to an embodiment in the present invention.

FIG. 7 is a diagram illustrating operation of input signal (INPUT 1 to INPUT 3), keyboard operation, and output signal (OUTPUT A to OUTPUT C) according to an embodiment in the present invention.

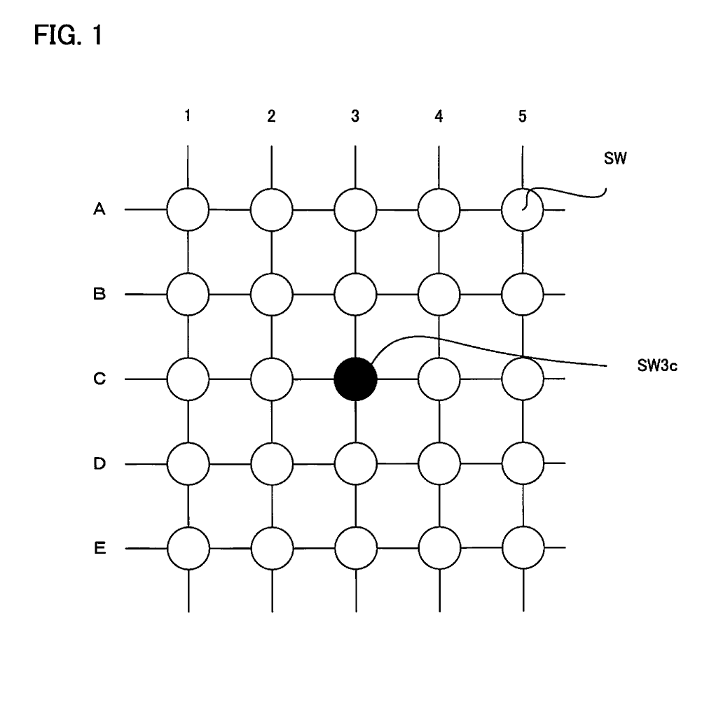

### DETAILED DESCRIPTION OF THE PREFERRED EMBODIMENTS

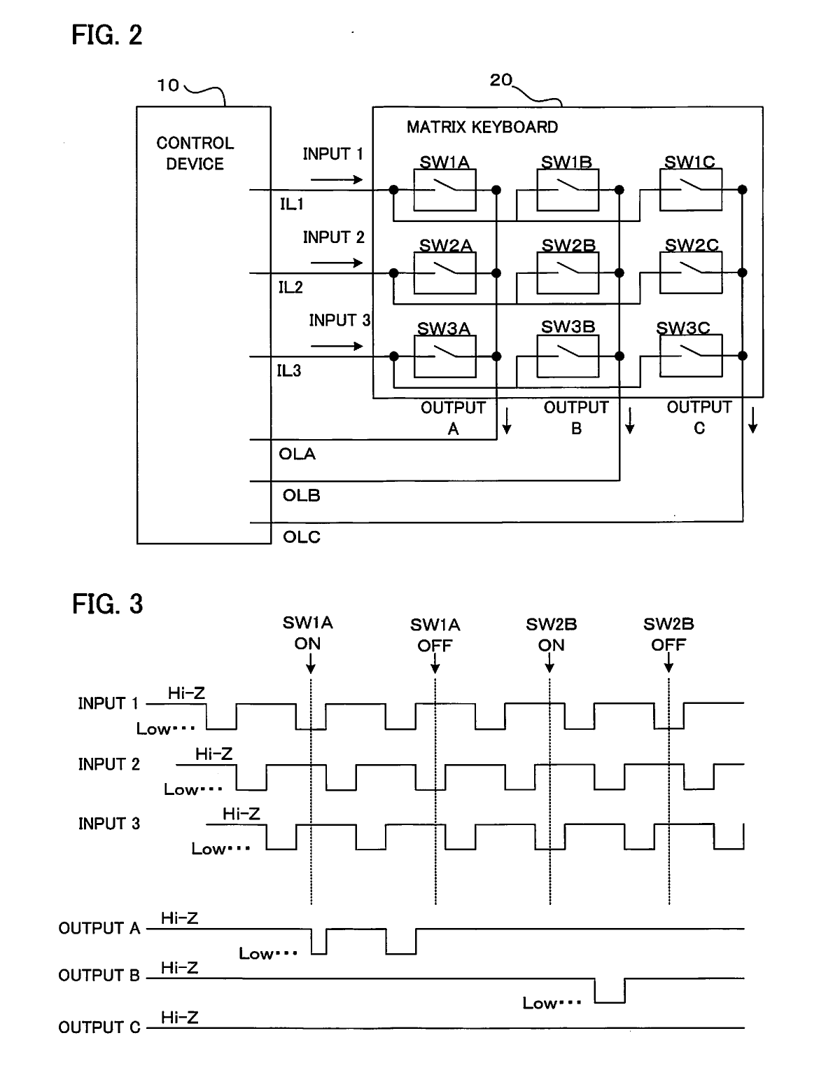

FIG. 2 is a schematic diagram illustrating an example of the prior art of a system in which a matrix keyboard with contact switches and a control device is connected via a line.

In the matrix keyboard 20, a plurality of input signal lines are provided as lateral lines and a plurality of output signal lines as longitudinal lines are provided, and contact switches SW for conduct the lateral lines and the longitudinal lines are provided at the intersection points of the lateral lines and the longitudinal lines. In the example shown in FIG. 2, an example in which three input signal lines IL1 to IL3, to which INPUT 1 to 3 are input respectively, and three output signal lines OLA to OLC which outputs OUTPUT A to C respectively, is shown. The input lines IL1 to IL3 are connected to an output of a control device 10, while the output signal lines OLA to OLC are connected to an input of the control device 10.

Contact switches SW1A, SW2A, SW3A, SW1B, SW2B, SW3B, SW1C, SW2C and SW3C are provided at the intersection points of the input signal lines IL1 to IL3 as lateral lines and the output signal lines OLA to OLC as longitudinal lines. When a contact switch at the intersection of an input signal line and an output signal line is turned on, the input signal line and the output signal line are conducted to each other, and the input signal input from the input signal line is output to the output signal line.

FIG. 3 is a diagram illustrating operation of input signal (INPUT 1 to INPUT 3), keyboard operation, output signal (OUTPUT A to OUTPUT C) in the system, and shows an example when a contact switch SW1A and a contact switch SW2B are turned on and off.

Input signals (INPUT 1 to INPUT 3) as shown in FIG. 3 are input from the control device 10 to the input signal lines IL1 to IL3 of a matrix keyboard 20. The input signal is repeatedly output at each predetermined period from the control device 10, and each input signal is input with shifted phase to each other such that pulses of the input signals are not piled up. For example, when generation period of each input signal is T, pulse width of each input signal is w, and number of input lines is n, Equation (1) below is satisfied and pulses of the input signals are output from the control device 10 so as not to overlap each other.

T≧n×w (1)

Here, as shown in FIG. 3, when the contact switch SW1A is turned on and turned off, the input signal line IL1 and the output signal line OLA is connected while the contact switch SW1A is turned on, so the input signal (INPUT 1) input from the input signal line IL1 is output to the output signal line OLA as the output signal (OUTPUT A). The control device 10 receives the output signal (OUTPUT A), and detects that the contact switch SW1A is turned on.

Similarly, when the contact switch SW2B is turned on and turned off, the input signal line IL2 and the output signal line OLB is connected while the contact switch SW2B is turned on, so the input signal (INPUT 2) input from the input signal line IL2 is output to the output signal line OLB as the output signal (OUTPUT B). The control device 10 receives the output signal (OUTPUT B), and detects that the contact switch SW2B is turned on.

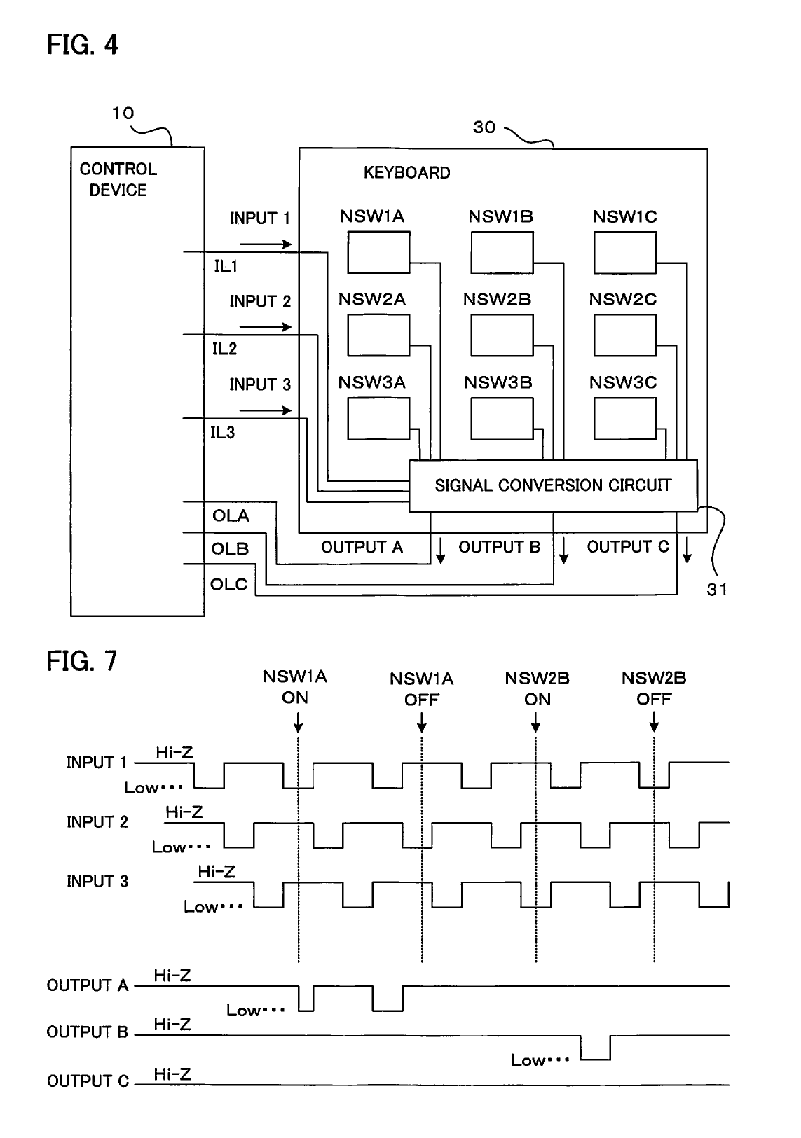

FIG. 4 is a schematic diagram of a system using the keyboard 30 with contactless switches according to an embodiment in the present invention.

In the keyboard 30, contactless switches (NSW1A, NSW2A, NSW3A, NSW1B, NSW2B, NSW3B, NSW1C, NSW2C and NSW3C) are provided corresponding to arrangement positions of each contact switch (SW1A, SW2A, SW3A, SW1B, SW2B, SW3B, SW1C, SW2C and SW3C) of the matrix keyboard 20 using the contact switches shown in FIG. 2. These contactless switches (NSW1A to NSW3C) may be provided on a film attached to a screen of a display.

In addition to that, in the present embodiment, a signal conversion circuit 31 comprising a PLD, the PLD being a programmable IC, is provided. Each contactless switch NSW1A to NSW3C is connected to the signal conversion circuit 31. Furthermore, the signal conversion circuit 31 is connected to each input signal line (IL1, IL2, and IL3) and the input signals (INPUT 1 to INPUT 3) from the control device 10 are input. The signal conversion circuit 31 is also connected to each output signal line (OLA, OLB, and OLC) and outputs the output signals (OUTPUT A, OUTPUT B, and OUTPUT C) to the control device 10.

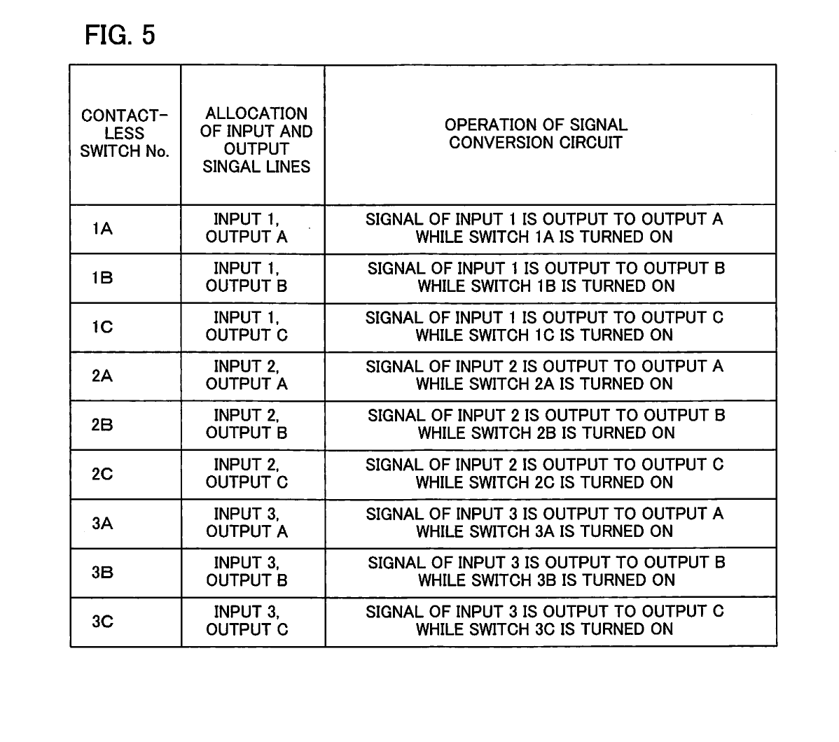

FIG. 5 is a diagram illustrating input and output allocated to each contactless switch NSW1A to NSW3C, which is programmed by the signal conversion circuit 31, and operation.

The input signal line IL1 (INPUT 1) and the output signal line OLA (OUTPUT A) are allocated to the contactless switch NSW1A, while the contactless switch NSW1A is turned on, the input signal (INPUT 1) input form the input signal line IL1 is output to the output signal line OLA as the output signal (OUTPUT A) by the signal conversion circuit 31.

The input signal line IL1 (INPUT 1) and the output signal line OLB (OUTPUT B) are allocated to the contactless switch NSW1B, while the contactless switch NSW1B is turned on, the input signal (INPUT 1) input form the input signal line IL1 is output to the output signal line OLB as the output signal (OUTPUT B) by the signal conversion circuit 31.

Similarly, the input signal lines (input signals) and output signal lines (output signals) are allocated to each contactless switch NSW1C, NSW2A, NSW2B, NSW2C, NSW3A, NSW3B, and NSW3C as shown in FIG. 5, and the signal conversion circuit 31 operates as shown in FIG. 5.

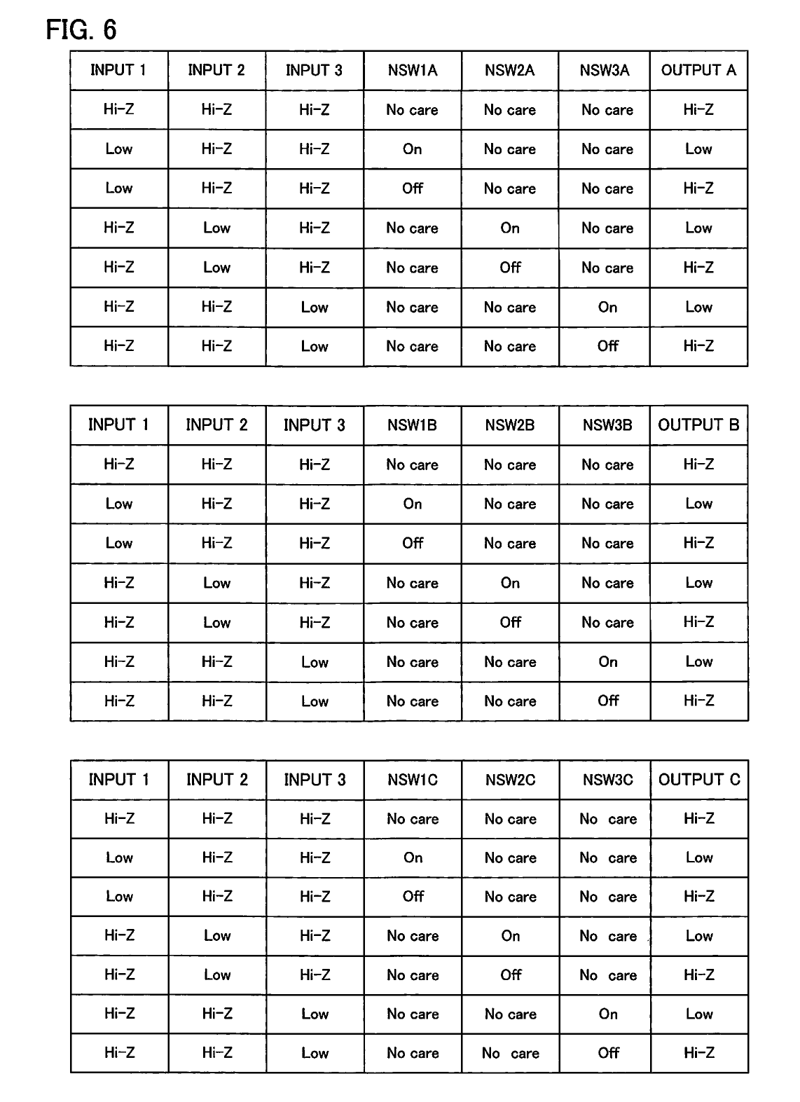

FIG. 6 is a diagram illustrating relation between input, each contactless switches, and output according to an embodiment in the present invention. Output signal of “Low” is output from the OUTPUT A when INPUT 1 is “LOW” and the contactless switch NSW1A is “ON”, when INPUT 2 is “LOW” and the contactless switch NSW2A is “ON”, and when INPUT 3 is “LOW” and the contactless switch NSW3A is “ON”. Similarly, Output signal of “Low” is output from the OUTPUT B when INPUT 1 is “LOW” and the contactless switch NSW1B is “ON”, when INPUT 2 is “LOW” and the contactless switch NSW2B is “ON”, and when INPUT 3 is “LOW” and the contactless switch NSW3B is “ON”. Output signal of “Low” is output from the OUTPUT C when INPUT 1 is “LOW” and the contactless switch NSW1C is “ON”, when INPUT 2 is “LOW” and the contactless switch NSW2C is “ON”, and when INPUT 3 is “LOW” and the contactless switch NSW3C is “ON”. Note that the “No care” in FIG. 6 represents that On and Off of the switch does not matter.

FIG. 7 is a diagram illustrating operation of input signal (INPUT 1 to INPUT 3), keyboard operation, and output signal (OUTPUT A to OUTPUT C) according to the present embodiment. An example in which the contactless switch NSW1A and the contactless switch NSW2B are turned on and off is shown, and the same operation is performed as the operation of turning on and off the contact switch SW1A and the contact switch SW2B using the matrix keyboard which uses the conventional contact switches.

When the matrix keyboard is changed to the keyboard using the contactless switches in a system using the matrix keyboard which uses the contact switches, the keyboard is simply changed such that, the contactless switches are arranged corresponding to the contact switches of the matrix keyboard, and the signal conversion circuit 31 comprising the PLD (Programmable Logic Device) is provided, and the signal conversion circuit 31 is programmed.

1. A keyboard having a plurality of contactless switches, the keyboard comprising:
a signal conversion circuit allocating an input signal line from a control device and an output signal line to the control device for each operating switch of the contactless switches; wherein
the signal conversion circuit is configured to output the signal of the input signal line allocated to the operating switch to the output line allocated to the operating switch when the contactless switch is operated.

2. A keyboard according to claim 1 wherein the signal conversion circuit comprises a PLD, the PLD being a programmable IC.

3. A keyboard according to claim 1 wherein the plurality of contactless switches are provided on a film attached on a screen of a display unit.
